(19) United States
(12) Patent Application Publication
(10) Pub. No.: US 2021/0324229 A1
(43) Pub. Date: Oct. 21, 2021

(54) HEAT-CURABLE COATING COMPOSITIONS CONTAINING SILANE-FUNCTIONAL POLYURETHANE RESINS CATALYZED BY AMIDINE SALTS

(71) Applicants: Corey KING, Center Valley, PA (US); Michael BRIGNONE, Norristown, PA (US); John HARTMANN, Medford, NJ (US); Tobias UNKELHÄUßER, Dülmen (DE); Evonik Operations GmbH, Essen (DE)

(72) Inventors: Corey King, Furlong, PA (US); Michael Brignone, Norristown, PA (US); John Hartmann, Medford, NJ (US); Tobias Unkelhäußer, Lüdinghausen (DE)

(73) Assignee: Evonik Operations GmbH, Essen (DE)

(21) Appl. No.: 17/267,676

(22) PCT Filed: Aug. 21, 2018
(86) PCT No.: PCT/US2018/047162

§ 371 Date: Feb. 10, 2021

(51) Int. Cl. C09D 175/04; C08G 18/20; C08G 18/32; C08G 18/71; C08G 18/48

(52) U.S. Cl. CPC C09D 175/04; C08G 18/2063; C08G 18/3206; C08G 2150/00; C08G 18/4825; C08G 18/4854; C08G 18/718

(57) ABSTRACT

The present invention provides for a coating composition comprising a silane-functional polyurethane and an amidine salt catalyst. The present invention also provides for a process for curing the coating composition comprising curing at elevated temperatures at or above 40° C., where the coating composition is tack free after 30 min.

### FIELD OF THE INVENTION

This invention relates to heat-curable coating compositions containing silane-functional polyurethane resins catalyzed by amidine salts, and to processes for curing the compositions.

### BACKGROUND OF THE INVENTION

Silane-functional polyurethane (SPUR) resin based systems are used as sealing materials, coating compositions, adhesives, and the like, in a variety of fields. The coating compositions are used for coating metal, glass, plastic and wood surfaces. SPUR resins allow for polyurethane performance and a moisture-curable system without exposure in the field to isocyanates. When cured, they can exhibit high chemical and scratch resistances.

Modern coatings of all kinds, especially finishes in the automotive sector, are subject to exacting requirements in terms of scratch resistances. Numerous approaches have been made in the past to obtain the highest scratch resistance of topcoats via combinations of polyurethane (PU) crosslinking and silane crosslinking (WO 2008/074489A1, WO 2008/110229A3, WO 2006/042658A, WO 2008/110230A, EP1273640A, DE 102004050747). Isocyanate-free systems are known and have been described (EP 1802716B1, WO 2008/131715A1, WO 2008/034409). Generally speaking, the scratch resistance is dependent on the crosslinking density, in other words on the amount of silane monomers or —Si(OR)₃— groups present in the polymer network.

Silane functional polyurethane (SPUR) crosslinkers can be synthesized via a reaction between an isocyanatoalkylalkoxysilane and various diols and/or hydroxy-functional oligomers. Coating compositions containing these SPUR crosslinkers are generally cured in a one-stage cure system at ambient temperature. An amine catalyst is often used to catalyze the curing of the SPUR coating compositions at this temperature.

U.S. Pat. No. 9,796,876 describes a curable composition comprising a silane-functional polyurethane resin catalyzed by catalysts such as Sn, Bi, Zn and other metal carboxylates, and tertiary amines such as 1,4-diazabicyclo[2.2.2]octane (DABCO) and triethylamine.

U.S. Pat. No. 8,841,399 describes a curable composition comprising dual reactive silane functionality catalyzed by at least one base selected from amidines, guanidines, phosphazenes, proazaphosphatranes, and combinations thereof. These compositions are moisture-cured in a one-stage cure system at ambient temperature.

Although amines catalyze these SPUR resin based compositions in 1K and 2K coating systems rapidly at ambient temperature, these catalysts have issues with volatilization at elevated temperatures. Should the catalysts disclosed in the above-referenced patents volatilize out of the coating, they cannot sufficiently catalyze the silane functional polyurethane crosslinker at these elevated temperatures.

It is an object of the present invention to provide a coating composition that allows for dual-curing (moisture-cure and heat-cure at elevated temperatures), short dry-to-touch times, with continued development of physical properties using catalysts previously not summarized in literature.

### BRIEF SUMMARY OF THE INVENTION

The present invention relates to coating compositions produced from dual-curing of silane-functional polyurethane resins in a one-component coating using amidine salt catalysts. The instant invention can solve problems associated with heat-curable coating compositions that disadvantageously use amine catalysts that volatize at elevated temperatures.

The problem on which the invention is based is solved in a first aspect by a coating composition comprising a silane-functional polyurethane and an amidine salt catalyst. The silane functional polyurethane crosslinkers are based on the reaction between an isocyanatoalkylalkoxysilane and various alkane diols and/or hydroxy-functional oligomers. Suitable silanes include methoxysilanes or ethoxysilanes. Suitable hydroxy-functional oligomers include oligomeric or polymeric structures that can contain urethane linkages. Examples of suitable isocyanatoalkylalkoxysilanes include 3-isocyanatopropyltrimethoxysilane (IPMS) and 3-isocyanatopropyltriethoxysilane (IPES).

The amidine salt catalysts include salts of 1,8-Diazabicyclo[5.4.0]undec-7-ene (DBU) and salts of 1,5-Diazabicyclo(4.3.0)non-5-ene (DBN). These amidine salt catalysts catalyze the silane-functional polyurethane (SPUR) crosslinkers at elevated temperatures (at or above 40° C.) in short time-frames (<1 hour) without issues of volatilization or decreased reactivity.

The present invention also provides for a process for curing the coating composition comprising curing at elevated temperatures at or above 40° C., where the coating composition is tack free after 30 min.

### DETAILED DESCRIPTION OF THE INVENTION

This invention relates to a coating composition comprising a silane functional polyurethane and an amidine salt catalyst.

This invention also relates to a process for curing the coating composition comprising curing at elevated temperatures at or above 40° C., where the coating composition is tack free after 30 min.

The silane functional polyurethane crosslinkers are based on the reaction between an isocyanatoalkylalkoxysilane and various alkane diols and/or hydroxy-functional oligomers. Suitable silanes include methoxysilane or ethoxysilane. Suitable hydroxy-functional oligomers include oligomeric or polymeric structures that can contain urethane linkages.

In one embodiment, the isocyanatoalkylalkoxysilane used is a compound of formula (I):

OCN-(alkyl)-Si(alkoxy)₃ (I)

in which (alkyl) denotes linear or branched alkyl chains having 1-4 carbon atoms, and in which (alkoxy) each independently is methoxy or ethoxy groups. Suitability as isocyanatoalkylalkoxysilane is possessed by, for example, 3-isocyanatopropyltrimethoxysilane (IPMS) and/or 3-isocyanatopropyltriethoxysilane (IPES).

The diols are selected from the group consisting of 1,6-hexanediol, 1,5-pentanediol, 1,4-butanediol, 2,2,4-trimethylhexane-1,6-diol, 2,4,4-trimethylhexane-1,6-diol, 2,2-dimethylbutane-1,3-diol, 2-methylpentane-2,4-diol, 3-methylpentane-2,4-diol, 2,2,4-trimethylpentane-1,3-diol, 2-ethylhexane-1,3-diol, 2,2-dimethylhexane-1,3-diol, 3-methylpentane-1,5-diol, 2-methylpentane-1,5-diol, 2,2-dimethylpropane-1,3-diol (neopentyl glycol), neopentyl glycol hydroxypivalate, 1,1,1-trimethylolpropane, 3(4),8(9)-bis(hydroxymethyl)tricyclo[5.2.1.02,6]decane (Dicidol) and/or 2,2-bis(4-hydroxycyclohexyl)propane alone or as any desired mixtures of these compounds.

The hydroxy-functional oligomers are selected from the group consisting of polypropylene glycols, polybutylene glycols, diethylene glycols, dipropylene glycols, triethylene glycols and tetraethylene glycols. Suitable polyfunctional diols with n>2 are glycerol, hexanediol, hexane-1,2,6-triol, butane-1,2,4-triol, tris(p-hydroxyethyl)isocyanurate, mannitol or sorbitol.

The diols and hydroxy-functional oligomers that are used may also, additionally, contain up to a fraction of 40% by weight of further diols and/or polyols. These diols and/or polyols may be selected from compounds of low molecular mass and/or from hydroxyl-containing oligomers.

Examples of suitable low molecular mass compounds include ethylene glycol, 1,2- and 1,3-propanediol, diethylene glycol, dipropylene glycol, triethylene glycol, tetraethylene glycol, 1,2- and 1,3-butylethylpropanediol, 1,3-methylpropanediol, bis(1,4-hydroxymethyl)cyclohexane (cyclohexanedimethanol), glycerol, hexane-1,2,6-triol, butane-1,2,4-triol, tris(.beta.-hydroxyethyl)isocyanurate, mannitol, sorbitol, polypropylene glycols, polybutylene glycols, xylylene glycol or hydroxyacrylates, alone or as mixtures.

Suitable additional polyols may include hydroxyl-containing polymers such as, polyesters, polyethers, polyacrylates, polycarbonates and polyurethanes having an OH number of 20 to 500 mg KOH/gram and an average molar mass of 250 to 6000 g/mol. Particular preference may be given to using hydroxyl-containing polyester and/or polyacrylates having an OH number of 20 to 150 mg KOH/gram and an average molecular weight of 500 to 6000 g/mol.

Being non-crystallizing compounds of low molecular mass the silane functional polyurethane crosslinkers of the invention are liquid at temperatures of more than 0° C. Depending on the selected stoichiometry of the two reactants, the silane functional polyurethane crosslinker may contain free hydroxyl or isocyanate groups. On the basis of the preferred embodiment, the silane functional polyurethane crosslinkers of the invention are substantially free from hydroxyl and isocyanate groups. In solvent-free form, the silane functional polyurethane crosslinker of the invention may be of low to medium viscosity and liquid at 0° C. For better handling, however, the products may also be admixed with solvents, which like alcohols may also be protic. The solids contents of such silane functional polyurethane crosslinkers are preferably greater than 80% by weight and preferably have a maximum viscosity of 5,000 mPas (DIN EN/ISO 3219 23° C.)

The silane functional polyurethane crosslinker of the invention of isocyanatoalkyltrialkoxysilane and branched diols or hydroxy-functional oligomers may be used advantageously as a crosslinking component for non-isocyanate (NISO) clearcoats with enhanced chemical and scratch resistances. When employed for a clearcoat, for the purpose of optimizing the mechanical qualities of the coating, the silane functional polyurethane crosslinkers may be blended with polymeric binders, which may also carry crosslinkable functional groups such as hydroxyls. As the reactivity of the silane functional polyurethane crosslinker of the invention is not sufficient for a practical curing rate at elevated temperatures, the crosslinking rate may be increased by addition of catalysts.

The crosslinking catalysts of the present invention are amidine salts. In one embodiment, the amidine salt catalyst may comprise at least one salt of 1,8-diazabicyclo[5.4.0]undec-7-ene (DBU) selected from a salt of DBU and phenol (Catalyst A), a salt of DBU and ethylhexanoic acid (Catalyst B), or a combination thereof.

In a further embodiment, the amidine salt catalyst may comprise at least one salt of 1,5-Diazabicyclo(4.3.0)non-5-ene (DBN) using carboxylic acids or hydroxyl functional molecules. In one embodiment, the amidine salt catalyst may comprise at least one salt of 1,5-Diazabicyclo(4.3.0)non-5-ene (DBN) selected from a salt of DBN and phenol, a salt of DBN and ethylhexanoic acid, or a combination thereof.

The amidine salt catalysts of the present invention provide the advantage of slower reactivity at ambient temperature which allows for delayed action of the catalyst until a disassociation temperature is reached at elevated temperature and the reaction can proceed to allow resulting coatings having a dry-to-touch time within 30 minutes.

The amount of amidine salt catalyst present in the coating composition is about 0.50 to about 1.00% by weight.

The amount of silane functional polyurethane present in the coating composition is about 50.00 to about 99.50% by weight. In another embodiment, the amount of silane functional polyurethane present in the coating composition is about 90.00 to about 99.50% by weight. In a further embodiment, the amount of silane functional polyurethane present in the coating composition is about 94.50 to about 99.50% by weight.

The coating compositions in accordance with the invention may be solvent-free or solvent-containing; with particular preference, the coating materials may be non-aqueous. Non-aqueous according to the present invention includes a water content in the coating composition of not more than 1.0% by weight, preferably not more than 0.5% by weight, based on the coating composition. With particular preference, the coating system used may be free of water.

The coating compositions in accordance with the invention may contain solvents selected from but not limited to butyl acetate, ethyl acetate, xylene, toluene, 1,2-dichlorobenzene, 1,3-dichlorobenzene, 1,4-dichlorobenzene, methyl ethyl ketone, methyl amyl ketone, cyclohexanone, parachlorobenzotrifluoride, heptane, isoparaffinic hydrocarbons, t-butyl methyl ether, tetrahydrofuran (THF), solvent naphtha, and mixtures thereof. The solvent content may range from 0-50% by weight of the coating composition.

The present disclosure also provides for a process for curing the coating composition comprising a silane functional polyurethane and an amidine salt catalyst comprising curing at elevated temperatures at or above 40° C., where the coating composition is tack free after 30 min. In one embodiment, the coating composition is cured at temperatures in the range of 40-150° C. In another embodiment, the coating composition is cured at temperatures in the range of 40-80° C. Curing times for these embodiments are less than one hour and can range from 10 to 60 minutes.

The coating composition is cured by a dual-curing mechanism. By “dual-curing” in the context of the present invention is meant the generation of a tack-free coating on a substrate by moisture cure and heat cure. Heat cure is the heating of the coating composition that has been applied to the substrate, at an elevated temperature above ambient temperature, for at least until the desired tack-free state has been reached. Heat-curing the coating composition is done by force-curing in an oven at an elevated temperature. Moisture cure is the curing of a coating composition that has been applied to the substrate in the presence of atmospheric moisture (humidity). Moisture curing the coating composition is done by water absorption into the coating where the water will react with the silanes to generate silanols, which further self-condense to form a crosslinked film. Substrates that the coating composition may be applied to include but are not limited to wood, plastic, glass, or metal.

### EXAMPLES

These Examples are provided to demonstrate certain aspects of the invention and shall not limit the scope of the claims appended hereto.

### Example 1

Preparation of a Silane Functional Polyurethane Resin Using an Isocyanatoalkoxysilane and 1,6-Hexanediol

22.5 g of 1,6-hexanediol are charged to a 250 mL 3 necked flask and admixed with 0.2 g of dibutyltin dilaurate (DBTDL) with stirring. Under a continuous flow of nitrogen in the flask headspace the mixture is heated to 60° C. in a water bath. Subsequently, with stirring, 72.4 g of 3-isocyanatopropyltrimethoxysilane are added dropwise at a rate such that the temperature of the reaction mixture does not climb above 70° C. Following complete addition, the reaction mixture is to be stirred at 60° C. for 6 hours. The free NCO content is then <0.1%. The product is a clear liquid of medium viscosity.

### Example 2

Preparation of the Heat Curable Coating Compositions Containing Silane Functional Polyurethane Resins

TABLE 1
General Clear Coat Formulation

| Chemical | % by wt |
|---|---|
| Silane Functional Polyurethane Resin | 98.90-99.40 |
| Catalyst | 0.50-1.00 |
| Tego Glide 410 | 0.10 |

It should be noted that the formulation in Table 1 is simply a guide and is not strictly adhered to for all coatings formulations that were evaluated. The examples to follow will summarize the coating formulations in more detail.

### Example 3

A 30 g mixture containing 99.40% by mass Silane Functional Polyurethane Resin, 0.50% by mass phenol blocked 1,8-Diazabicyclo[5.4.0]undec-7-ene and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 4

A 30 g mixture containing 98.90% by mass Silane Functional Polyurethane Resin, 1.00% by mass phenol blocked 1,8-Diazabicyclo[5.4.0]undec-7-ene and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 5

A 30 g mixture containing 99.40% by mass Silane Functional Polyurethane Resin, 0.50% by mass 2-ethylhexanoic acid blocked 1,8-Diazabicyclo[5.4.0]undec-7-ene, and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 6

A 30 g mixture containing 98.90% by mass Silane Functional Polyurethane Resin, 1.00% by mass 2-ethylhexanoic acid blocked 1,8-Diazabicyclo[5.4.0]undec-7-ene, and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 7

A 30 g mixture containing 98.90% by mass Silane Functional Polyurethane Resin, 1.00% by mass 2-ethylhexanoic acid blocked 1,4-Diazabicyclo[2.2.2]octane, and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 8

A 30 g mixture containing 94.90% by mass Silane Functional Polyurethane Resin, 5.00% by mass 3-aminopropyltrimethoxysilane (Evonik Corporation, Piscataway, N.J.), and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 9

A 30 g mixture containing 98.90% by mass Silane Functional Polyurethane Resin, 1.00% by mass tert-Octylimino-tris(dimethylyamino)phosphorene (Phosphazene base P₁-t-Oct, Sigma Aldrich Chemical Company, St. Louis, Mo.), and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 10

A 30 g mixture containing 98.90% by mass Silane Functional Polyurethane Resin, 1.00% by mass 1,4-Diazabicyclo[2.2.2]octane (Evonik Corporation, Allentown, Pa.), and 0.10% by mass Tego Glide 410 (Evonik Corporation, Richmond, Va.) were combined in a max 40 g mixing cup and speed mixed for 90 seconds at 1200 RPM using a DAC 150FVZ speed mixer from FlackTek. The coatings were drawn down on 0.8 mm thick iron phosphatized R-361 cold rolled steel panels from Q-Lab (Cleveland, Ohio) at 1.0-1.5 mil dry film thickness using a stainless steel bird bar. The coatings were cured in an oven at temperatures of 40, 60, and 80° C. for not less than 10 minutes but not more than 60 minutes.

### Example 11

Determination of Catalyst Effectiveness within Cure Window

The films prepared from the coating formulation in Table 1 and detailed in Examples 3-10 were considered cured if the film was not tacky to the touch after the curing schedule detailed in Example 3. If the coating film was tacky to the touch after the above described cure schedule, that particular catalyst was deemed not cured. Table 2 summarizes the results of the coating formulations from Examples 4 and 6-10 with their respective catalysts.

TABLE 2
Curing Results with Various Amine, Amidine and
Comparison Catalysts at 1% Loading

| Example | Catalyst | Cured |
|---|---|---|
| 4 | 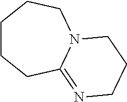 [SMILES: C1CCC2=NCCCN2CC1] 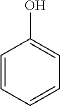 | Yes |
| | phenol blocked DBU (1,8-Diazabicyclo | |
| | [5.4.0]undece-7-ene) | |
| | (Catalyst A) | |
| 6 | 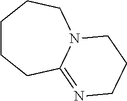 [SMILES: C1CCC2=NCCCN2CC1] 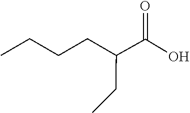 | Yes |
| | 2-ethyl-hexanoic acid blocked DBU (1,8- | |
| | Diazabicyclo[5.4.0]undece-7-ene) (Catalyst B) | |
| 7 | 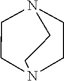 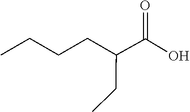 | No |
| | 2-ethyl-hexanoic acid blocked DABCO (1,4- | |
| | Diazabicyclo[2.2.2]octane) (Catalyst C) | |
| 8 | 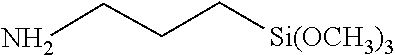 | No |
| | 3-aminopropyltrimethoxysilane (Catalyst D) | |
| 9 | 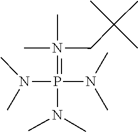 | No |
| | Phosphazene base P₁-t-Oct (Catalyst E) | |
| 10 | 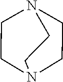 | No |
| | DABCO | |
| | (1,4-Diazabicyclo[2.2.2]octane) (Catalyst F) | |

After the initial curing cycle detailed above, the coatings were removed from the oven and the Konig pendulum hardness was measured following ASTM D4366-95. A pendulum resting on a coating surface is set into oscillation (rocking) and the time for the oscillation amplitude to decrease by a specified amount is measured. The shorter the damping time, the lower the hardness. The longer the damping time the higher the hardness. The coated panels were then placed in an Associated Environmental Systems LH-10 control chamber where they were exposed to 23° C. and 50% relative humidity conditions for seven days. The Konig pendulum hardness was again measured following ASTM D 4366-95. For the coating compositions detailed in Examples 4 and 6-10 with the respective catalysts from Table 2, the Konig hardness measurements are presented in Table 4 for the coatings that were deemed cured after their cure schedule detailed in the Examples section. For the coating compositions detailed in Examples 3 and 5 and the coating compositions from Examples 7-10 at 0.5% loading, the Konig hardness measurements are presented in Table 3 for the coatings that were deemed cured after their cure schedule detailed in the Examples section.

TABLE 3
Hardness Development of the Coatings With Respect To Time at 0.5% loading

| | Catalyst A | | | Catalyst B | | | Catalyst C | | |
|---|---|---|---|---|---|---|---|---|---|
| Cure T (° C.) | 40° C. | 60° C. | 80° C. | 40° C. | 60° C. | 80° C. | 40° C. | 60° C. | 80° C. |
| Post-cure (s) | 74 | 53 | 67 | n/a* | 68 | 52 | n/a* | n/a* | n/a* |
| 7 days (s) | 133 | 134 | 126 | n/a* | 129 | 124 | n/a* | n/a* | n/a* |
| | Catalyst D | | | Catalyst E | | | Catalyst F | | |
| Cure T (° C.) | 40° C. | 60° C. | 80° C. | 40° C. | 60° C. | 80° C. | 40° C. | 60° C. | 80° C. |
| Post-cure (s) | n/a* | n/a* | n/a* | n/a* | n/a* | n/a* | n/a* | n/a* | n/a* |
| 7 days (s) | n/a* | n/a* | n/a* | n/a* | n/a* | n/a* | n/a* | n/a* | n/a* |

*did not cure

TABLE 4
Hardness Development of the Coatings With Respect To Time at 1.0% loading

| | Catalyst A | | | Catalyst B | | | Catalyst C | | |
|---|---|---|---|---|---|---|---|---|---|
| Cure T (° C.) | 40° C. | 60° C. | 80° C. | 40° C. | 60° C. | 80° C. | 40° C. | 60° C. | 80° C. |
| Post-cure (s) | 47 | 42 | 43 | n/a* | 37 | 37 | n/a* | n/a* | n/a* |
| 7 days (s) | 136 | 136 | 133 | n/a* | 127 | 119 | n/a* | n/a* | n/a* |
| | Catalyst D | | | Catalyst E | | | Catalyst F | | |
| Cure T (° C.) | 40° C. | 60° C. | 80° C. | 40° C. | 60° C. | 80° C. | 40° C. | 60° C. | 80° C. |
| Post-cure (s) | n/a* | n/a* | n/a* | n/a* | n/a* | n/a* | n/a* | n/a* | n/a* |
| 7 days (s) | n/a* | n/a* | n/a* | n/a* | n/a* | n/a* | n/a* | n/a* | n/a* |

*did not cure

The following invention is directed to the following aspects:

<1> A coating composition comprising (a) a silane functional polyurethane comprising the reaction product of an isocyanatoalkylalkoxysilane and at least one alkane diol or hydroxyl-functional oligomer; and (b) an amidine salt catalyst.
<2> The coating composition of aspect <1> wherein the isocyanatoalkylalkoxysilane is selected from the group consisting of 3-isocyanatopropyltrimethoxysilane and 3-isocyanatopropyltriethoxysilane.
<3> The coating composition of aspect <1> wherein the at least one alkane diol is selected from the group consisting of 1,6-hexanediol, 1,5-pentanediol, 1,4-butanediol, 2,2,4-trimethyl hexane-1,6-diol, 2,4,4-trimethyl hexane-1,6-diol, 2,2-dimethyl butane-1,3-diol, 2-methylpentane-2,4-diol, 3-methylpentane-2,4-diol, 2,2,4-trimethylpentane-1,3-diol, 2-ethylhexane-1,3-diol, 2,2-dimethylhexane-1,3-diol, 3-methylpentane-1,5-diol, 2-methylpentane-1,5-diol, 2,2-dimethylpropane-1,3-diol, neopentyl glycol hydroxypivalate, 1,1,1-trimethylolpropane, 3(4),8(9)-bis(hydroxymethyl)tricyclo[5.2.1.02,6]decane, 2,2-bis(4-hydroxycyclohexyl)propane, or any combination.
<4> The coating composition of aspect <1> wherein the hydroxyl-functional oligomer is selected from the group consisting of polypropylene glycols, polybutylene glycols, diethylene glycols, dipropylene glycols, triethylene glycols and tetraethylene glycols.
<5> The coating composition of aspect <1> wherein the hydroxyl-functional oligomer is selected from hydroxyl-containing polymers selected from the group consisting of polyesters, polyethers, polyacrylates, polycarbonates and polyurethanes having an OH number of 20 to 500 mg KOH/gram and an average molar mass of 250 to 6000 g/mol.
<6> The coating composition of aspect <1> wherein the amidine salt catalyst is at least one salt of 1,8-diazabicyclo[5.4.0]undec-7-ene.
<7> The coating composition of aspect <1> wherein the amidine salt catalyst is at least one salt of 1,5-diazabicyclo(4.3.0)non-5-ene.
<8> The coating composition of aspect <6> wherein the at least one salt of 1,8-diazabicyclo[5.4.0]undec-7-ene is selected from the group consisting of a salt of 1,8-diazabicyclo[5.4.0]undec-7-ene and phenol, and a salt of 1,8-diazabicyclo[5.4.0]undec-7-ene and ethylhexanoic acid.
<9> The coating coating composition of aspect <1> wherein the amount of amidine salt catalyst present in the coating composition is about 0.50 to about 1.00% by weight.
<10> The coating composition of aspect <1> wherein the amount of silane functional polyurethane present in the coating composition is about 50.00 to about 99.50% by weight.
<11> A process for curing the coating composition of aspect <1> comprising (a) applying the coating composition of aspect <1> onto a substrate; and (b) heating the coating composition on the substrate at a temperature in the range of 40−150° C.
<12> The process of aspect <11> wherein the cure time ranges from 10 to 60 min.
<13> The process of aspect <11> wherein the coating composition is tack free after 30 min.

What is claimed is:

1. A coating composition comprising
(a) a silane functional polyurethane comprising the reaction product of an isocyanatoalkylalkoxysilane and at least one alkane diol or hydroxyl-functional oligomer; and
(b) an amidine salt catalyst.

2. The coating composition of claim 1 wherein the isocyanatoalkylalkoxysilane is selected from the group consisting of 3-isocyanatopropyltrimethoxysilane and 3-isocyanatopropyltriethoxysilane.

3. The coating composition of claim 1 wherein the at least one alkane diol is selected from the group consisting of 1,6-hexanediol, 1,5-pentanediol, 1,4-butanediol, 2,2,4-trimethylhexane-1,6-diol, 2,4,4-trimethylhexane-1,6-diol, 2,2-dimethylbutane-1,3-diol, 2-methylpentane-2,4-diol, 3-methylpentane-2,4-diol, 2,2,4-trimethylpentane-1,3-diol, 2-ethylhexane-1,3-diol, 2,2-dimethylhexane-1,3-diol, 3-methylpentane-1,5-diol, 2-methylpentane-1,5-diol, 2,2-dimethylpropane-1,3-diol, neopentyl glycol hydroxypivalate, 1,1,1-trimethylolpropane, 3(4),8(9)-bis(hydroxymethyl)tricyclo[5.2.1.02,6]decane, 2,2-bis(4-hydroxycyclohexyl)propane, or any combination.

4. The coating composition of claim 1 wherein the hydroxyl-functional oligomer is selected from the group consisting of polypropylene glycols, polybutylene glycols, diethylene glycols, dipropylene glycols, triethylene glycols and tetraethylene glycols.

5. The coating composition of claim 1 wherein the hydroxyl-functional oligomer is selected from hydroxyl-containing polymers selected from the group consisting of polyesters, polyethers, polyacrylates, polycarbonates and polyurethanes having an OH number of 20 to 500 mg KOH/gram and an average molar mass of 250 to 6000 g/mol.

6. The coating composition of claim 1 wherein the amidine salt catalyst is at least one salt of 1,8-diazabicyclo[5.4.0]undec-7-ene.

7. The coating composition of claim 1 wherein the amidine salt catalyst is at least one salt of 1,5-diazabicyclo(4.3.0)non-5-ene.

8. The coating composition of claim 6 wherein the at least one salt of 1,8-diazabicyclo[5.4.0]undec-7-ene is selected from the group consisting of a salt of 1,8-diazabicyclo[5.4.0]undec-7-ene and phenol, and a salt of 1,8-diazabicyclo[5.4.0]undec-7-ene and ethylhexanoic acid.

9. The coating composition of claim 1 wherein the amount of amidine salt catalyst present in the coating composition is about 0.50 to about 1.00% by weight.

10. The coating composition of claim 1 wherein the amount of silane functional polyurethane present in the coating composition is about 50.00 to about 99.50% by weight.

11. A process for curing the coating composition of claim 1 comprising
(a) applying the coating composition of claim 1 onto a substrate; and
(b) heating the coating composition on the substrate at a temperature in the range of 40−150° C.

12. The process of claim 11 wherein the cure time ranges from 10 to 60 min.

13. The process of claim 11 wherein the coating composition is tack free after 30 min.
